(19) United States
(12) Patent Application Publication
(10) Pub. No.: US 2021/0090576 A1
(43) Pub. Date: Mar. 25, 2021

(54) Real Time and Delayed Voice State Analyzer and Coach

(71) Applicant: Giving Tech Labs, LLC, Seatte, WA (US)

(72) Inventors: Luis Salazar, Kirkland, WA (US); Ying Li, Bellevue, WA (US)

(73) Assignee: Giving Tech Labs, LLC, Seatte, WA (US)

(21) Appl. No.: 16/576,733

(22) Filed: Sep. 19, 2019

(51) Int. Cl. G10L 17/00; G10L 25/63; G09B 19/00

(52) U.S. Cl. CPC G10L 17/005; G09B 19/00; G10L 25/63

(57) ABSTRACT

A system may monitor the voice state of a person speaking and may give immediate, real time feedback, as well as track the speaker's voice state during a verbal interaction alone, with one or many individuals. A system may have a set of pre-built analyzers, which may be generated for different languages, regions or dialects, gender, subgroups or other factors, as well as use cases such as public speaking, sales, caregiving, teaching or counseling among others. The analyzers may operate on a local device, such as a cellular telephone, wearable device or local computer, and may analyze a person's spoken voice to identify and classify the person's voice state and provide feedback or coaching to the individual based on certain defined parameters. The person may provide training data by inputting either parameters or their voice state during a verbal interaction or afterwards; the user can also provide training data by asking the audience their agreement or disagreement with the elicited or perceived emotion after the verbal interaction, and this training data may be used to update and personalize the voice analyzer and improve the confidence level of the voice engine. The analysis systems may be configured for different speech situations, such as one to one conversations, one to many lectures or seminars, group conversations, as well as conversations with specific types of people, such as children or those with cognitive or intellectual disabilities.

### BACKGROUND

Our voices can convey many different types of thoughts, ideas, feelings, and intents. In many cases, we express these thoughts, ideas, feelings, and intents in our speech without consciously controlling how our voices carry them and as a consequence we fail to achieve the communication results we wanted, and unintended effects may arise that negatively impact our relationship. To effectively communicate with others, how we say things is as important as what we say.

The challenges in communication through our voices are amplified in situations of stress such as presentations, speeches, sales interactions, dates, emergency situations, teaching a class, or conversations related to healthcare, among others. In addition to this, for individuals in the spectrum of neurological disorders such as Autism, Down's syndrome, and others. The communication challenges extend to caregivers of persons with these conditions when their voices carry unintended affect or fail to carry intended affect in order to communicate with persons under their care.

Early intervention in the form of timely feedback, as well as continuous coaching based on performance over time help individuals to improve the way in which they communicate with others by changing how they express themselves in the most optimal way given the situation: speech, sales interaction, caregiving, early childhood education, dating, and others.

### SUMMARY

A system may monitor the various characteristics of a person speaking and may give immediate, real time feedback, as well as track the speaker's measured and inferred metrics on these characteristics during a conversation. A system may have a set of pre-built analyzers, which may be generated for different languages, regions or dialects, gender, or other factors. The analyzers may operate on a local device, such as a cellular telephone, wearable device, or local computer, and may analyze a person's spoken voice and emitted sounds to identify and classify the person's vocal states derived from the metrics of voice characteristics. The person may provide label data by inputting their voice state, or the results of the verbal interaction, or the affect elicited in others, during a conversation or afterwards, and this label data may be used to retrain, update, and personalize the voice analyzer and coach. The analysis systems may be configured for different speech situations, such as one to one conversations, one to many lectures or seminars, group conversations, as well as conversations with specific types of people, such as children or persons with a disability. It might also be configured for specific desired outcomes of the verbal interaction, such as inspire others, convince them of something, teach something, calm down a listener, keep them engaged, among others. The user can use label data to retrain and update the voice analyzer and coach on two different dimensions: agreement or not with the measured and inferred metrics of the person speaking, and agreement or not with the inferred metrics related to the audience of such verbal interaction; for example, the audience was engaged, the audience calmed down, and others.

A real time voice analyzer may analyze a person's speech to identify characteristic features, such as inflection, rate of speech, tone, volume, modulation, and other parameters. The analyzer may also infer attributes such as speaker emotional state or the emotional reaction of the audience. The voice analyzer may identify characteristic features and inferred attributes without the need to identify the words spoken and hence it may offer maximum preservation of the user privacy. One or more of these parameters may be displayed in real time through visual, haptic, audio, or other feedback mechanisms, thereby alerting the speaker of their voice state and giving the speaker an opportunity to adjust their speech. A set of desired voice conditions may be defined for a conversation and the feedback may be tailored to help a speaker achieve the desired conditions as well as avoid undesirable conditions. The set of voice conditions may be updated over time by collecting feedback after the conversation to determine whether or not the set of voice conditions served to achieve the goal of the conversation or not. Various sets of voice conditions may be constructed for dealing with specific situations, as well as for conversing with specific types of people, such as in a workplace environment, within a personal relationship, a public speech, a classroom setting, as well as with persons having specific intellectual or cognitive differences, such as persons who may be autistic or have Down's syndrome.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an example embodiment showing a voice analyzer in a network environment.

FIG. 2 is a diagram illustration of an embodiment showing a network environment with a voice analyzer as well as a voice analyzer management system.

FIG. 3 is a flowchart illustration of an embodiment showing a method for processing audio using a voice analyzer.

FIG. 4 is a flowchart illustration of an embodiment showing a method for configuring an audio analyzer system prior to processing audio.

FIG. 5 is a flowchart illustration of an embodiment showing a method for tagging voice states from audio clips.

FIG. 6 is a diagram illustration of an example embodiment showing a series of user interfaces for an audio analysis system.

### DETAILED DESCRIPTION

Real Time and Delayed Voice Analyzer and Coach

A voice analyzer and coach may operate on a device, such as a wearable device or a cellular telephone, to identify various characteristic features of speech. The characteristic features may directly or indirectly, as inferred attributes, identify the voice state of the speaker, as well as whether the speaker is asking questions, speaking in a soothing or calming tone, engaging the audience, speaking in an angry or aggressive way, or other characteristics.

A voice segment can be analyzed using two types of properties: calculated features and inferred features. In many instances, calculated features may be identified and measured first and used as an input to identify inferred features.

The calculated features are also referred to as characteristic features, and include directly measurable or calculatable features, such as frequency, amplitude, speed, volume, and the like. These characteristic features may be measured directly, such as through a Fourier analysis or other algorithms. In other cases, the characteristic features may be estimated using, for example, a neural net or other lightweight analyzer that may not calculate these features directly.

The inferred attributes may include features that cannot be directly measured. These may include inferences about a speaker's or audience's intent, feelings, thoughts. These inferred attributes may often be computed by using the calculated features as inputs. In many systems, a human-guided training system may identify specific emotions, intents, feelings, or other inferred characteristics, and the human-guided input may be used to train a machine learning system to properly identify these features. Throughout this specification and claims, the term “voice state” is used to identify these inferred attributes or features.

The voice analyzer may be implemented, for example, in a supervised or unsupervised machine learning architecture, where a voice engine may be trained with pre-identified audio clips. The voice analyzer may be lightweight enough to operate on hand-held or wearable devices. Because the analyzers may operate within the confines of a single device a user's privacy may not be violated by transferring audio data to a third party, such as a cloud computing resource, for analysis.

The user's privacy may also be ensured because a voice-engine analysis of an audio stream may characterize the speech without having to convert the speech to text. The lack of text conversion and the ability for the analyzer to operate within a user's device may therefore limit how the user's speech may be transmitted or used outside their control.

The voice analyzer and coach may be able to analyze characteristic features and inferred attributes to distinguish between the user voice or verbal interaction. Such information may be useful in separating a user's voices from background noises within an audio stream.

A voice analyzer and coach, may operate in a real time or a delayed feedback mode. In a real time mode, the voice analyzer may identify certain characteristics, such as tension or anger, and may notify the speaker right away. One such example may be a version where an output mechanism may be a haptic sensor on a cellular telephone or a smart watch. When a user may be perceived as angry, the haptic sensor may buzz, indicate that the user should try to modify his tone, inflection, rate of speech or volume in order to maximize the efficiency of verbal interaction.

In another use case, a speaker to a large audience may have a device on a lectern during a speech. The device may give real time feedback about the speaker's cadence, pitch, emotional intensity, level of elicited engagement, or other characteristic features or inferred attributes during the speech.

A delayed feedback mode may give feedback to the speaker after the fact. In one such use case, a device may present a statistical summary of the user's speaking cadence, or may indicate what percentage of the time the user elicited emotions of engagement or conveyed a sense of calmness, or used an upbeat tone. Such a use case may be used to analyze a conversation or series of conversations so that the voice analyzer and coach assists a person to track and modify their behavior over time.

In a specific implementation of this type of system, caregivers or teachers may have their speech patterns monitored with their patients or students. The historical analysis may help the caregiver or teacher recognize different speech strategies that may be helpful in communicating. For example, a caregiver may recognize that they spend much less time than they thought being calming and soothing, and may try to increase that type of communication. In another example, a teacher's classroom speech may indicate that the teacher spends more time lecturing and instructing and less time asking questions. The teacher may try to increase the classroom interaction by asking more questions in future teaching sessions.

Feedback Mechanism

A user may train their speech analyzer and coach by manually labeling the characteristic features and the inferred attributes of their voice state for sections of their speech. For example, during or after a conversation has been captured and analyzed, the user has the option to agree or disagree with the assessment of the voice analyzer. In addition to the user input, the user may ask the audience for feedback and use that feedback to agree or disagree with the voice analyzer assessment on the elicited emotion. The user's input may be used to retrain and improve the analyzer and coaching features for the user's specific speech as well as different levels of background noise.

In many cases, a default voice analyzer and coach may be deployed for a user. The default voice analyzer may be trained with a set of voice clips having predefined characteristics. The default voice analyzer and coach may be pre-trained with default settings for optimal characteristic features on specific situations such as speaking at a specific rate of speech when speaking in a classroom setting, in a public speech, or when acting as a caregiver of a young child. While such a default voice analyzer and coach may not be as accurate as a user may like because the training data may not correlate with the user's actual voice characteristics and inferred attributes, it offers a starting point anchored on generally accepted concepts related to best practices in verbal interactions.

The feedback may be collected in real time, as the user speaks, or later, after a conversation has ended. One version of a feedback mechanism may present the user with a small number of choices of their voice state, such as a list of cadence states on a visual display, and the user may select their actual cadence state from the list.

A feedback mechanism may identify audio clips where a set of voice states have been identified with a certain confidence, and then ask the user to confirm which state was correct, both, from the user point of view, or self-assessment, and from the audience point of view, to confirm the elicited emotions on said audience. For example, such an interface may detect that the user was angry, then ask the user if indeed the user was angry at that time. The user's selection may be used to retrain the analyzer to improve its accuracy.

The feedback mechanism may customize the analyzer for a specific person. That person's voice characteristics and voice states may be incorporated into the analyzer, and that customized analyzer may become more and more tuned to the speaker's voice state.

The feedback mechanism may customize the analyzer for a specific culture, ethnicity, affinity group, or country. As feedback is gathered from the different groups, customized analyzers may become more and more tuned to the specific audience. Over time, many different analyzers may be tuned for specific groups based on the training data. For example, a speaker from the USA might use a different feedback mechanism when speaking to an audience in Brazil or in China. In another example, an angry emotion in the United States or Chile or even Peru, but the same tone and inflection may be an engaging conversation in Brazil or other parts of Latin America. Each

The feedback mechanism may collect voice state information as the ground truth for training an analyzer. In many cases, an analyzer may measure certain characteristics, such as volume, cadence, and the like, and may infer voice state from these characteristics. Such systems may use the measured characteristics as inputs to a voice analyzer to aid in estimating or inferring a speaker's voice state.

System for Managing Voice Analyzers

Some systems may have multiple default voice analyzers available for download and use. Default voice analyzers may be created for different languages, regions or dialects within a language, genders, age, affinity groups, and other characteristics of users. Each of the default voice analyzers may be tuned for a specific language with regional, dialect, gender, and other differences. Once available, a user may select the analyzer that most closely suits the user specific coaching needs, then download and begin using the analyzer.

As the user trains their analyzer to that user's unique voice characteristics and voice state, their analyzer may be retrained over and over, improving with each piece of feedback. Over time, their analyzer will improve its accuracy and reliability.

Some analyzers may be constructed for persons with specific intellectual and cognitive differences. Autism, for example, is a condition where a person may have difficulty perceiving and expressing emotions. A voice state analyzer and coach may be helpful for the autistic person to recognize other people's emotions, or how the user might be perceived by others. It is hoped that the voice analyzer may assist caregivers, parents, teachers, counselors, and any other people who interact with some individuals with intellectual and cognitive differences by giving them real-time and delayed feedback and coaching on how to better engage in verbal interactions with them.

Throughout this specification, like reference numbers signify the same elements throughout the description of the figures.

In the specification and claims, references to “a processor” include multiple processors. In some cases, a process that may be performed by “a processor” may be actually performed by multiple processors on the same device or on different devices. For the purposes of this specification and claims, any reference to “a processor” shall include multiple processors, which may be on the same device or different devices, unless expressly specified otherwise.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be, for example but not limited to, an electronic, magnetic, optical, electromagnetic, infrared, or semiconductor system, apparatus, device, or propagation medium. By way of example, and not limitation, computer readable media may comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by an instruction execution system. Note that the computer-usable or computer-readable medium could be paper or another suitable medium upon which the program is printed, as the program can be electronically captured, via, for instance, optical scanning of the paper or other medium, then compiled, interpreted, of otherwise processed in a suitable manner, if necessary, and then stored in a computer memory.

When the subject matter is embodied in the general context of computer-executable instructions, the embodiment may comprise program modules, executed by one or more systems, computers, or other devices. Generally, program modules include routines, programs, objects, components, data structures, etc. that perform particular tasks or implement particular abstract data types. Typically, the functionality of the program modules may be combined or distributed as desired in various embodiments.

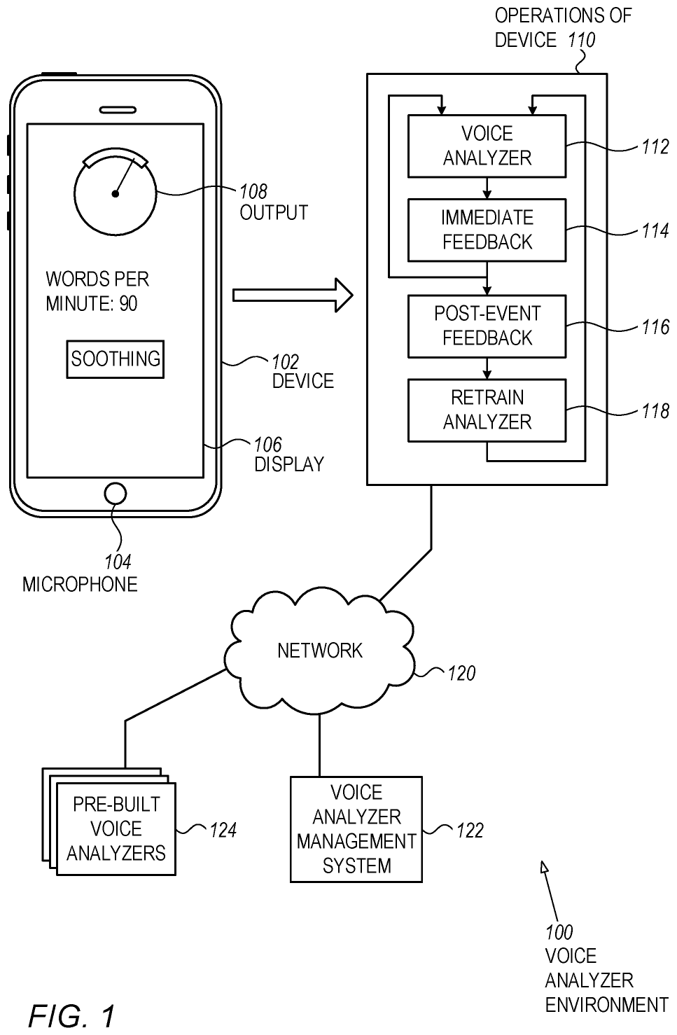

FIG. 1 is a diagram illustration showing a voice analyzer and its environment. A device 102 may be a cellular telephone or other device which may have a microphone 104, which may capture an audio stream of a person speaking, and a display 106, which may show output 108 showing real time characteristics of the speech. The output 108 may include performance metrics or characteristics, such as cadence, volume, pitch, and the like, as well as an voice state of the speaker.

The device 102 may perform operations 110, where a voice analyzer 112 may provide some immediate feedback 114. In some cases, the user may provide post-event feedback 116, which may be used to retrain 118 the voice analyzer.

The device 102 may operate in a network environment 120, where a voice analyzer management system 122 may transmit the executable code to the device 102, as well as provide one or more pre-built voice analyzers 124 according to the user's request. The pre-built voice analyzers 124 may be voice analyzers that may be tailored to different languages and dialects, and some analyzers may be further configured for gender, age, and other differences of speakers.

The pre-built voice analyzers 124 may be installed and operated on the device 102, and then the installed analyzers may be further tuned or refined by the user feedback 116.

The voice analyzer 112 may provide two different levels of analysis. In one level, various characteristic features may be derived from the audio feed. Such characteristics may include frequency analysis, cadence, volume, tone, pitch, and other measurable quantities. Another level of analysis may include inferred attributes from those characteristics such as voice state of the speaker, taking into account the cultural context where the verbal interaction happens: country, institution, affinity group, or the purpose of said verbal interaction: teaching, public speaking, provide care, etc.

The voice analyzer 112 may involve algorithmic analysis of the audio waveform as well as voice engine analysis comprised of supervised and unsupervised learning modules. The voice engine analyzer may use the raw waveform and the measured characteristics of the waveform to generate an estimated voice state of the speaker. The post-event feedback 116 may create ground truth data that can be used to retrain the neural network analyzer to improve its accuracy.

The system may be useful in several different scenarios.

In a voice coaching scenario, a user may have the voice analyzer 112 give real time or delayed feedback for various conversation regimes. A conversation regime may be the situation in which a person interacts with others. For example, different conversation regimes may include a one on one conversation, a public speech, a sales presentation, a group discussion, a conversation with a loved one, a conversation with a child, a conversation with an individual that has cognitive or intellectual disabilities, an interactive teaching session, and others.

In each conversation regime, a speaker's expected behavior may be much different. For example, a rousing, enthusiastic speech at a rally has much different than a quiet, personal discussion at bedtime with a child. The expected behavior for each regime may be dramatically different, and the feedback associated with the individual regimes may be much different.

The feedback 114 may be based on expected or desired behaviors for a person in a particular situation. The feedback 114 may be based on measured parameters, such as volume and cadence, that are appropriate for the situation. The feedback 114 may include an output of a measured parameter, such as the words per minute, as well as alarms or indicators when the person exceeds the limits.

In one use scenario, a user's conversation regime may be a speech to a large group. In such a regime, the user may have a tendency to speak very fast, or too loud when nervous, so the feedback 114 may include a haptic sensor which may tell the speaker when their speech is too fast or too slow, too loud or not loud enough. The haptic sensor may buzz when the speaker is going too fast, giving the speaker an alert to slow down, or may give two quick buzzes when the speaker talks too slow.

In another use scenario, a person may have a conversation with a person with a cognitive or intellectual disability. Some conditions, such as autism, cause a sensory overload in the individual suffering such condition. An untrained person, such as a social worker, or a parent of a new children experiencing some form of intellectual disability or cognitive differences such as autism may not be able to effectively communicate because their verbal interaction are not in line with the way in which the individuals suffering from such conditions react to different characteristic features such as volume, speed of speech, cadence, etc. A voice analyzer and coach trained for verbal interactions with autistic persons may help users learn how to better communicate with the autistic person. Conversely, a voice analyzer may also help the autistic person understand what others are trying to communicate.

The various verbal interaction regimes may include recommended or desired speech parameters as well as voice states. Each regime may have upper and lower limits, which may be used for alerting the user in real time. Additionally, each regime may have a recommended or desired allocation of voice states during a conversation. After a conversation, a user may be able to review their history to see which voice states they were in during a conversation.

A use scenario may be for early childhood educators and caregivers in an individual or classroom setting. A voice analyzer may track the caregiver's or teacher's inferred attributes to determine how much time the teacher was instructing students compared to how much time the teacher was asking questions of the students. It may also track the level of elicited engagement in the teacher or caregiver voice. The teacher or caregiver may review a classroom session after the fact and see how much time was used for questions, what percentage of the time an engaging tone was used or other relevant characteristic features and inferred attributes. The teacher or caregiver may have specific goals based on the age of the children in the classroom, agree or disagree with the voice analyzer and coach assessment at the end of the session and decide to change their approach the next session to achieve that goal.

The system of embodiment 100 may operate by analyzing audio streams without translating the audio to text. Some embodiments may analyze only the audio waveforms and, by avoiding converting the speech to text, may avoid certain privacy issues, such as storing people's otherwise private conversations. In some jurisdictions, such recording may be prohibited or otherwise restricted.

Further, the system of embodiment 100 may operate by analyzing audio waveforms on the device 102, without sending recorded audio over a network 120 for processing. Such analysis may keep any recordings and their analysis local and within a user's physical control, as opposed to risking a security breach if the recordings were transmitted over a network and stored on or processed by a third party's device.

When the voice processing is performed on a user's device 102, which may be a laptop computer, tablet, cellular telephone, or even a smart wearable device, such as a smart watch, the processing engines may be designed to be lightweight and to avoid consuming lots of power. One such architecture may be one or more pre-trained voice engine analyzers, which may be used to detect voice state, and in some cases, to further measure various characteristic features or inferred attributes from the waveform itself.

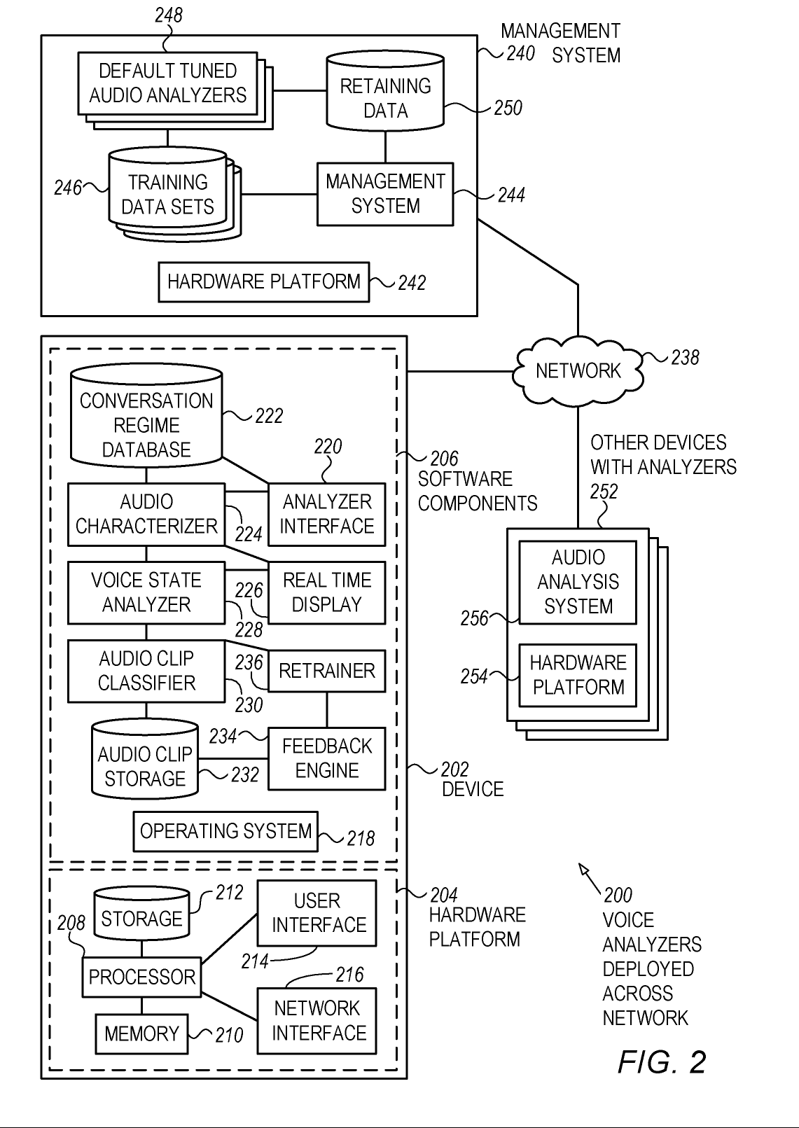

FIG. 2 is a diagram of an embodiment 200 showing components that may deploy voice analyzers on various devices across a network. Embodiment 200 is merely one example of an architecture that may analyze voice audio to determine various measured characteristics, as well as detect voice state of a speaker.

The diagram of FIG. 2 illustrates the functional components of a system. In some cases, the component may be a hardware component, a software component, or a combination of hardware and software. Some of the components may be application level software, while other components may be execution environment level components. In some cases, the connection of one component to another may be a close connection where two or more components are operating on a single hardware platform. In other cases, the connections may be made over network connections spanning long distances. Each embodiment may use different hardware, software, and interconnection architectures to achieve the functions described.

Embodiment 200 illustrates a device 202 that may have a hardware platform 204 and various software components. The device 202 as illustrated represents a conventional computing device, although other embodiments may have different configurations, architectures, or components.

In many embodiments, the device 202 may be a server computer. In some embodiments, the device 202 may still also be a desktop computer, laptop computer, netbook computer, tablet or slate computer, wireless handset, cellular telephone, wearable device, game console or any other type of computing device. In some embodiments, the device 202 may be implemented on a cluster of computing devices, which may be a group of physical or virtual machines.

The hardware platform 204 may include a processor 208, random access memory 210, and nonvolatile storage 212. The hardware platform 204 may also include a user interface 214 and network interface 216.

The random access memory 210 may be storage that contains data objects and executable code that can be quickly accessed by the processors 208. In many embodiments, the random access memory 210 may have a high-speed bus connecting the memory 210 to the processors 208.

The nonvolatile storage 212 may be storage that persists after the device 202 is shut down. The nonvolatile storage 212 may be any type of storage device, including hard disk, solid state memory devices, magnetic tape, optical storage, or other type of storage. The nonvolatile storage 212 may be read only or read/write capable. In some embodiments, the nonvolatile storage 212 may be cloud based, network storage, or other storage that may be accessed over a network connection.

The user interface 214 may be any type of hardware capable of displaying output and receiving input from a user. In many cases, the output display may be a graphical display monitor, although output devices may include lights and other visual output, audio output, kinetic actuator output, as well as other output devices. Conventional input devices may include keyboards and pointing devices such as a mouse, stylus, trackball, or other pointing device. Other input devices may include various sensors, including biometric input devices, audio and video input devices, and other sensors.

The network interface 216 may be any type of connection to another computer. In many embodiments, the network interface 216 may be a wired Ethernet connection. Other embodiments may include wired or wireless connections over various communication protocols.

The software components 206 may include an operating system 218 on which various software components and services may operate.

An analyzer and coach interface 220 may be a user interface through which a user may configure the device 202 for analyzing a voice. The analyzer and coach interface 220 may also include functions for setting up and configuring the analyzer system, as well as for launching different functions, such as reviewing historical data or processing audio clips for manual feedback.

A user may be presented with a set of verbal interaction regimes, from which the user may select one. The verbal interaction regimes may include public speeches, one to one conversations, presentations to a group, a group discussion, conversations with a loved one, child, or person with an intellectual or cognitive disability, an interactive teaching session, or other regime. When a regime is selected, the filters, analyzers, limits, and other information for that regime may be recalled from a conversation regime database 222 and applied to an audio characterizer 224 as well as an voice state analyzer 226.

A user may be presented with a set of cultural or subgroup settings, from which the user may select one. The cultural or subgroup may include specific countries or cultural regions such as Asia, Europe, Latin America, ethinc groups such as Hispanics in the USA or affinity groups such as Scientists at a conference . When a subgroup is selected, the filters, analyzers, limits, and other information for that subgroup may be recalled from a conversation regime database 222 and applied to an audio characterizer 224 as well as an voice state analyzer 226.

Once configured, the audio characterizer 224 and voice state analyzer 228 may begin analyzing an audio stream. The analyzers may isolate a specific person's speech from the audio input, then process that person's speech using settings associated with that person. During the processing, the analyzers 224 and 228 may produce output that may be presented on a real time display 226.

The real time display 226 may include a visual display, such as a graphical user interface that may display a meter showing a person's speech cadence or other measured parameter. The real time display 226 may also include haptic, audio, or other output that may serve to alert the user. In some cases, alerts may be produced when a user's speech falls below a predefined limit, such as when they may be speaking too softly, or may also be produced when the user's speech exceeds a limit, as when they may be speaking too loudly.

The audio characterizer 224 may generate measurable parameters from the speech. In some cases, the audio characterizer 224 may use a pure algorithmic architecture to measure volume, pitch, cadence, and the like. In other cases, the audio characterizer 224 may use a neural network or other architecture to estimate such parameters. Some systems may use a combination of architectures.

The voice state analyzer 228 may be a voice engine analyzer based on supervised and unsupervised models, which may be trained from several pre-classified samples or generally accepted concepts. In many systems, human operators may manually classify audio clips to determine a voice state of the speaker. In other cases, characteristic features accepted as ground truth, such as speaking at a specific speed when interacting with young children, are parameters entered in the system. The combination of these audio clips and manually entered data points may be the basis of training for the voice engine.

An audio clip classifier 230 may tag and segment audio clips. The tags may include the parameters determined by the audio characterizer 224, as well as the estimated voice state determined by the voice state analyzer 228. The clips may be stored in an audio clip storage 232.

A feedback engine 234 may be a process whereby a user may be presented with a previously recorded and tagged audio clip, and the user may confirm or change the estimated voice state or other parameters. It may also be a process whereby a user may be presented with an assessment of the voice state at the end of a verbal interaction, and it may give the user the opportunity to agree or disagree with the feedback. In some cases, the feedback engine 234 may allow an audience member to give input, in addition to or separate from the speaker. The user's feedback may generate additional training samples, or adjust the algorithms, which may be used by a retrainer 236 to improve the accuracy of the analyzers, most notably the voice state analyzer 228.

The retrainer 236 may retrain the voice engine with supervised and unsupervised learning modules architectures with updated samples. The samples may have a strong confidence since a user may have manually identified the parameters, including voice state, that the voice engine initially estimated.

The device 202 may be connected to a network 238, through which the device 202 may communicate with the management system 240.

The management system 240 may have a hardware platform 242 on which a management system 244 may reside. The management system 244 may upload executable code as well as data and various analyzers to the device 202, as well as the other devices 252 that may also have analyzers.

The management system 240 may have several training data sets 246. The training data sets 246 may come from generally accepted concepts well documented by experts, such as the right speed of speech, the use of inflection, etc, or by crowdsourcing self assessment by individuals listening and manually classifying speakers from different languages, dialects, genders, education, cognitive abilities, and other differences. Each of the training data sets 246 may have been used to create individual tuned audio analyzers 248, which may be some or part of the audio and voice state analyzers 224 and 228 on the device 202.

Some systems may be configured to receive retraining data 250 from the various devices 202 and 252. While there is no private identifiable information or PII in the datasets, such transmissions may be done when a user consents to the use of their manually-curated training data. The retraining data 250 may be used to further refine and tune the audio analyzers.

The other devices 252 may represent additional devices such as device 202, which may have a hardware platform 254 and may operate an audio analysis system 256. In many environments, there may be many hundreds, thousands, or even millions of devices that may be performing audio analysis. When a portion of those devices allow to have their manually-classified retraining data shared across the network, a large number of highly tuned audio analyzers 248 may be created for everyone to share.

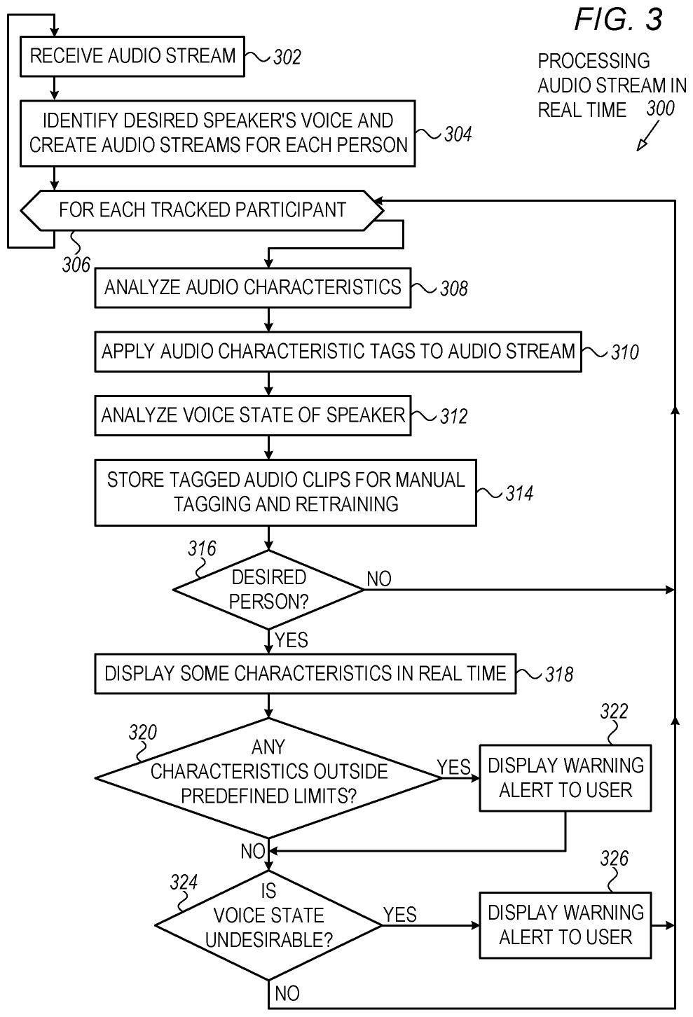

FIG. 3 is a flowchart illustration of an embodiment 300 showing a general method of processing an audio stream. The operations of embodiment 300 may represent those performed by a device that may capture an audio stream and provide feedback to a user, such as the device 202 illustrated in embodiment 200.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A device may receive an audio stream in block 302. In most embodiments, a device may have a microphone or set of microphones to capture an audio stream. Within the audio stream, separate audio streams may be captured for each person within the audio stream in block 304. Many embodiments may capture a specific person's voice for analysis and feedback.

Each person's audio stream may be processed in block 306. Embodiment 300 shows the processing of each person's audio stream, however, some embodiments may only process audio streams for specific people who may have been pre-identified. In many systems, a voice sample may be used to differentiate between one speaker and another, such that the appropriate analyses and tracking may be performed according to the individual speakers.

A person's audio stream may be analyzed in block 308 to determine audio characteristics. The audio characteristics may be parameters that may be measured or estimated from the acoustic waveform. Such characteristics may include parameters such as cadence or speed, volume, tone, inflection, pitch, and other such parameters. These parameters may be used to tag the audio stream in block 310.

The person's audio stream may be analyzed in block 312 to determine the speaker's voice state. The voice state may be tagged to the audio stream in block 314.

If the person's voice being analyzed is the desired speaker's voice in block 316, the characteristics of that speaker's voice may be displayed in block 318. If the person speaking is not the desired speaker's voice, the process may return to block 306 until another person begins speaking.

If any of the characteristics of the speech is outside predefined limits in block 320, a warning may be displayed to the user in block 322. Similarly, if the voice state of the user is undesirable in block 324, a warning may be displayed to the user in block 326. In many cases, the warning may be visual, audio, or haptic indication that the user has fallen outside of the desired boundaries for their speech.

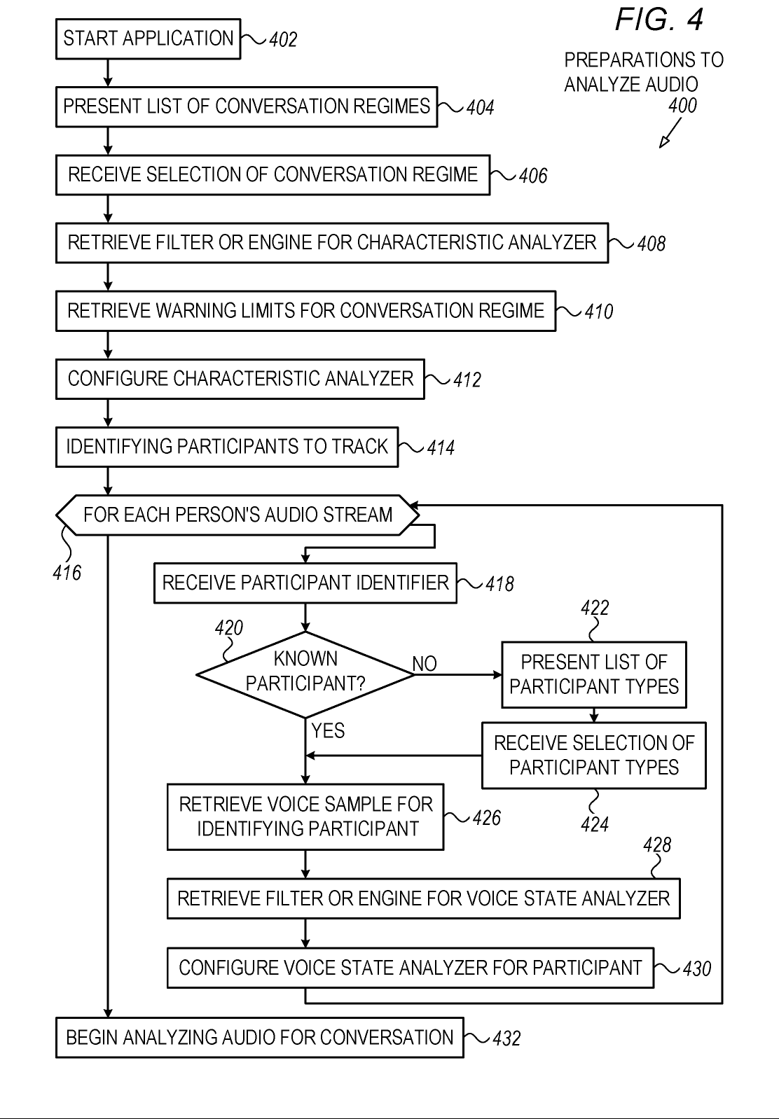

FIG. 4 is a flowchart illustration of an embodiment 400 showing a general method of preparing a system for processing an audio stream.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 400 illustrates one example method of how a set of audio analyzers may be configured prior to capturing and analyzing an audio stream. The process configures analyzers for a specific verbal interaction regime, then prepares analyzers that may be specifically configured for the speakers that may be tracked. Once complete, the audio analysis may begin.

An audio analysis application may be started in block 402.

A list of verbal interaction regimes may be presented to a user in block 404, and the selection may be received in block 406. The corresponding filter or analysis engine may be retrieved for the verbal interaction regime in block 408, and any predefined warning limits may also be retrieved in block 410. The characteristic analyzer may be configured using the filter and limits in block 412.

The participants to be tracked may be identified in block 414.

For each tracked participant in block 416, the participant's identifier may be received in block 418. If the participant identifier does not correspond with a known participant in block 420, a list of participant types may be presented in block 422, and a selection may be received in block 424.

A participant type may identify an individual user by their characteristics, such as the spoken language of the anticipated verbal interaction, the person's native language, their region or dialect, their age, gender, cultural group, and other characteristics. These characteristics may correspond with available voice state analyzers for the audio processing.

A voice sample may be received for the speaker in block 426. In one embodiment, a group setting may begin with each person speaking their name into the system, which may be used as both a voice sample and an identifier.

The filter or engine for a voice state analyzer may be retrieved in block 428 and configured in block 430 for the speaker. The process may return to block 416. Once all speakers are processed in block 416, the process may continue to begin analyzing audio in a conversation in block 432.

The terms “filter or engine” may refer to different ways an analyzer may be architected. In some cases, an analyzer may use an algorithmic approach to mathematically calculate certain values. Such analyzers may use the same algorithm with every analysis, but may apply different constants within the algorithm. Such constants may be referred to here by the shorthand “filter.” Other analyzers, such as voice engine with supervised or unsupervised learning modules analyzers, may be swapped out in their entirety from one selected user to another. In such a case, the entire analyzer “engine” may be replaced with another once trained with a different training set.

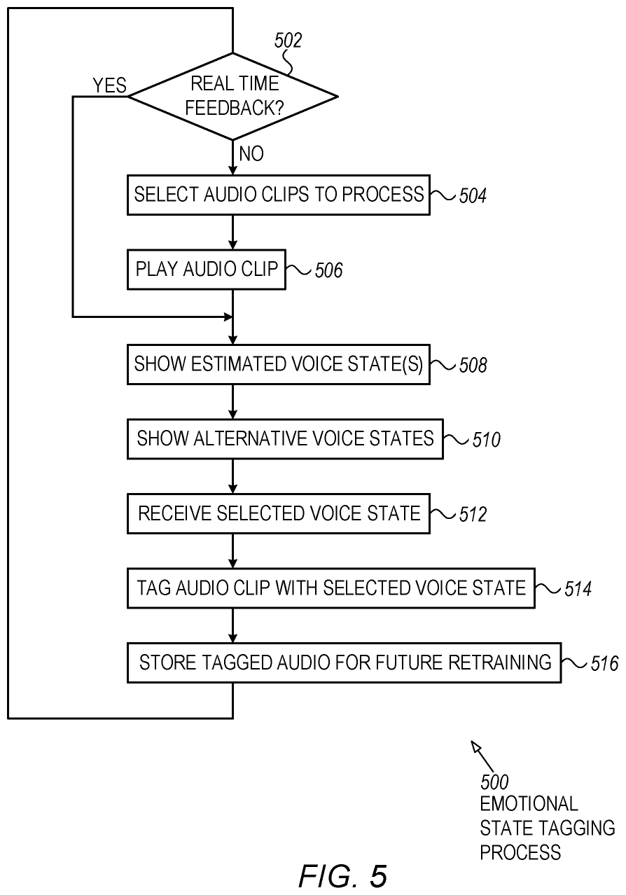

FIG. 5 is a flowchart illustration of an embodiment 500 showing a general method of tagging voice states to audio clips. The operations of embodiment 500 may be a mechanism by which a user may manually identify specific voice states from an audio stream and create tagged audio clips. The tagged audio clips may be used to retain neural network analyzers to improve the quality of estimation of voice states.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

The process of tagging voice states may be performed in a real time or after-the-fact manner. If the process is not done in real time in block 502, the audio clips to be tagged may be selected in block 504 and one of them played in block 506. If the process is done in real time, the user would have just heard the conversation.

As the audio clip is played or as words were spoken in a conversation, the voice state of the speaker may be analyzed and displayed in block 508. A selection of alternative voice states may be displayed in block 510, and the user may select one of the voice states, which would be received in block 512. The audio clip may be tagged in block 514 and stored in block 516 for subsequent retraining.

In one version of the process of embodiment 500, a voice state may be estimated using a voice state analyzer. The voice state may be presented along with alternative voice states, and the user may select the appropriate voice state. In many voice engine embodiments of a voice state analyzer, the voice engine with supervised and unsupervised learning modules may produce a confidence score of each available voice state. The list of voice states may be presented to the user using the voice engine confidence of the different states, and the user may override the selection to create a ground truth tagged sample, which may be used for retraining and improvement of the voice analyzer and coach.

After any session with the voice analyzer and coach, the user may be prompted with the opportunity to agree or disagree with the feedback given by the voice analyzer and coach, for example: too fast, or not engaging, or very calming voice. Some systems may allow the audience of such verbal interaction to agree or disagree with the voice analyzer assessment.

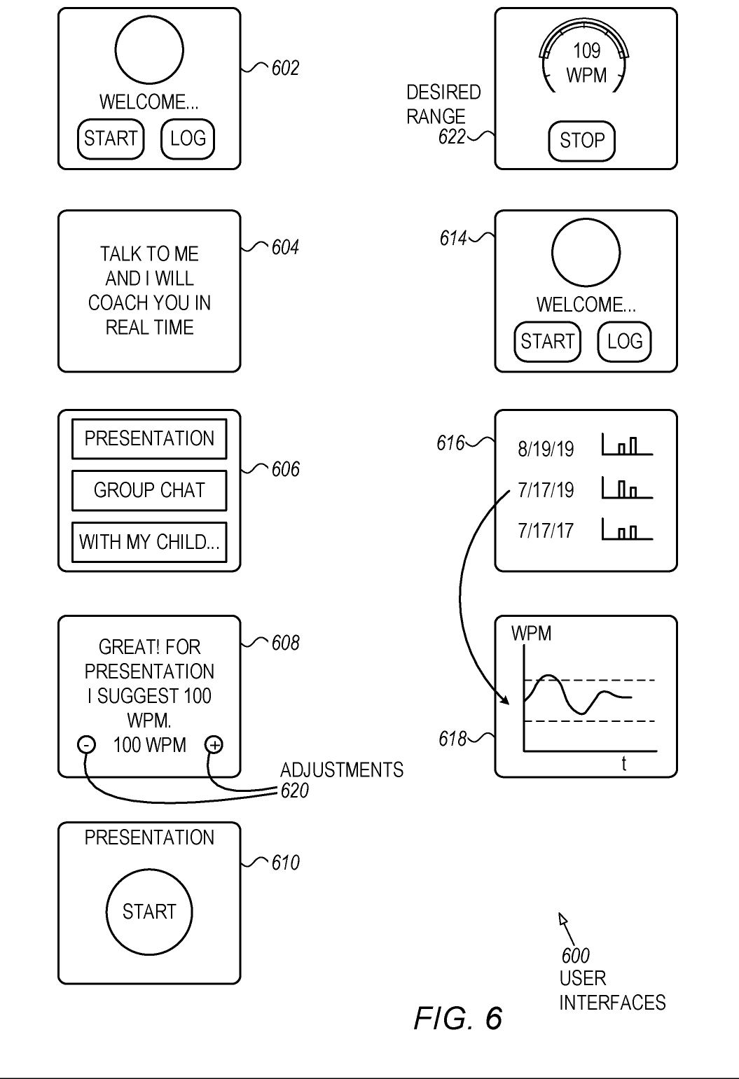

FIG. 6 is a diagram illustration of an embodiment 600 showing a succession of user interfaces, 602, 604, 606, 608, 610, 612, 614, 616, and 618. Each of the respective user interfaces may represent a user interface of a smart watch interface for a voice analyzer. The instance of this smart watch application example may be designed to monitor the wearer's voice and voice state, while other embodiments may be used to monitor two or more speakers in a conversation.

User interface 602 may illustrate a starting point for voice monitoring. The user interface may have a button to start analysis, as well as a button to examine the previously logged sessions. In some cases, an automatic feature may start analyzing a voice once the user's voice may be detected. Such a feature may stop analysis during pauses. In user interface 604, the application may guide the user through the configuration and operation.

A verbal interaction regime may be selected in user interface 606. In this example, conversation regimes of “presentation,” “group chat,” and “with a child” are given. A user may select one. In this example, the user has selected “presentation.”

In user interface 608, the measured parameter of words per minute may be suggested to be about 100 wpm. The user may have the option to adjust the target range using the adjustments 620. The system is configured to be used in user interface 622, and the user may select “start” to begin analysis.

During a user's speech, user interface 612 may display a dial interface showing the user's speech within a desired range 622. The display may be in real time, where the dial may go up or down during the speech. When the user has stopped their speaking, they may hit the “stop” button to cease the analysis.

User interface 614 may represent the starting point of the application, similar to user interface 602. In this example, the user may press the “log” button.

In user interface 616, the user may be presented with a series of logged events, each with a date and, in this example, with a tiny graph showing the data.

A user may select a date, which may bring up user interface 618, which may show a graph showing the user's words per minute over the duration of their speech.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

1. A device comprising:
at least one processor;
an audio input mechanism;
an output mechanism;
said processor configured to perform a method comprising:
determining a first conversation regime;
receive a first audio stream collected by said audio input mechanism;
identify a first person within said first audio stream to create a first person's audio stream;
determine a first measured parameter from said first person's audio stream; and
capturing an voice state feedback summary for said first person's audio stream.

2. The device of claim 1, said method further comprising:
presenting a list comprising a plurality of conversation regimes; and
receiving a selection of said first conversation regime from said list.

3. The device of claim 2, said list comprising a plurality of conversation regimes comprising one of a group composed of:
a one to one conversation;
a presentation to a group;
a group discussion;
a conversation with a loved one;
a conversation with a child;
a conversation with a disabled person; and
an interactive teaching session.

4. The device of claim 1, said method further comprising:
determining an estimated voice state of said first person during said first audio stream; and
presenting said estimated voice state on said output mechanism.

5. The device of claim 4, said estimated voice state comprising a state of heightened tension.

6. The device of claim 4, said output mechanism being a haptic mechanism.

7. The device of claim 4, said output mechanism being a visual display.

8. The device of claim 4, said determining an estimated voice state being determined by said at least one processor on said device.

9. The device of claim 8 further comprising a first trained analyzer used for said determining an estimated voice state, said first trained analyzer being downloaded to said device.

10. The device of claim 1 said capturing said emotional feedback summary comprising:
presenting a plurality of voice states on said output mechanism; and
receiving a first selection identifying a first voice state.

11. The device of claim 10, said method further comprising:
storing said first voice state as metadata associated with said first person's audio stream.

12. The device of claim 11, said method further comprising:
associating said first voice state with a specific location within said first person's audio stream.

13. The device of claim 4, said method further comprising:
replaying a first portion of said first person's audio stream;
receiving said first selection defining a first voice state expressed during said first portion of said first person's audio stream.

14. The device of claim 13, said method further comprising:
replaying a second portion of said first person's audio stream;
receiving a second selection defining a second voice state expressed during said second portion of said first person's audio stream.

15. The device of claim 14, said method further comprising:
retraining a first trained analyzer using said first selection and said second selection to create an updated trained analyzer; and
using said updated trained analyzer for analyzing a second audio stream.

16. A device comprising:
at least one processor;
access to a database comprising a plurality of voice state analyzers, each of said voice state analyzers being trained to detect voice states from audio streams, each of said voice state analyzers being trained using a set of speaker characteristics;
said processor configured to perform a first method comprising:
receiving a first set of speaker characteristics;
identifying a first voice state analyzer from said first set of speaker characteristics; and
transferring said first voice state analyzer to a user device.

17. The device of claim 16, said set of speaker characteristics comprising at least one of a group composed of:
language of said audio streams;
language of origin of speaker;
region or dialect of speaker;
disability of speaker;
age; and
gender.

18. The device of claim 17 further comprising:
an analyzer engine adapted to perform a second method comprising:
receiving a set of emotional identifiers from a first user, said first user being a user of said first voice state analyzer;
updating said first voice state analyzer into a first updated voice state analyzer using said set of emotional identifiers; and
making said first updated voice state analyzer available for downloading.

19. The device of claim 18, said set of emotional identifiers comprising at least one emotional indicator and a section of a first audio stream.

20. The device of claim 19, said first section of a first audio stream being represented by a set of summary variables.
